(19) United States
(12) Patent Application Publication
(10) Pub. No.: US 2010/0161163 A1
(43) Pub. Date: Jun. 24, 2010

(54) AUXILIARY APPARATUS OF WHEELED LUGGAGE

(76) Inventor: Nai-Chien CHANG, Sanchong City (TW)

Correspondence Address: HDLS Patent & Trademark Services, P.O. BOX 220746, CHANTILLY, VA, 20153-0746, US

(21) Appl. No.: 12/619,794

(22) Filed: Nov. 17, 2009

(30) Foreign Application Priority Data
Dec. 22, 2008 (TW) 097150085

(51) Int. Cl. B60L 11/00; H02K 7/116

(52) U.S. Cl. 701/22; 310/83

(57) ABSTRACT

An auxiliary apparatus of wheeled luggage, capable of being pulled, includes an electricity-generating unit, a charging unit, a storage unit, a control unit, a driving unit, an actuating unit, a transmission unit and a sensing unit. When the luggage is being pulled, the wheel set of the luggage generates power to bring along the electricity-generating unit to generate electricity. The output electricity is in turn charging the storage unit via the charging unit. In the meantime, the signal sensed by the sensing unit is judged by the control unit. If it is needed to generate an auxiliary power source, then a control signal is output from the control unit to drive the driving unit, making the actuating unit bring along the transmission unit, which in turn brings along the wheel set by using the generated auxiliary electricity. Therefore, the user can pull the wheeled luggage to walk with an easy effort.

### BACKGROUND OF THE INVENTION

1. Field of the Invention

The present invention in general relates to a luggage, in particular, to an auxiliary apparatus of wheeled luggage capable of being pulled by a user.

2. Description of Prior Art

Accordingly, because being busy in working, modern is loaded with heavy pressure. So, during holidays, most people rush out of town, go to country/mountain area, or go abroad for relaxing themselves and pursuing natural consolation, otherwise the pressure long accumulated in human body can not be released. This kind of pressure relaxation via travel has gradually become a trend nowadays.

In the past, when traveling out of town, most people will put their clothing and other articles of daily use in a luggage. During trip, most of the time, the luggage is transported by vehicle, airplane or carried by the service staff of hotel. In the other times, the luggage has to be carried by the traveler himself. When traveling a long distance with a large luggage, sometimes, the clothing or article of daily use putted therein is too heavy for the traveler to carry, so there is emerging a new generation of luggage, which is provided with auxiliary wheel or mechanism additionally to facilitate the traveler in pulling the luggage when walking. However, through these additional wheel or mechanism, the luggage is only a little easier for the user to carry, because there are still lots of labor needed to take, if too much staff is putted in the luggage.

Accordingly, after a substantially devoted study, in cooperation with the application of relative academic principles, the inventor has finally proposed the present invention designed reasonably to possess the capability to improve the drawbacks of the prior arts significantly.

### SUMMARY OF THE INVENTION

Therefore, in order to solve aforementioned problems, the invention is mainly to provide an auxiliary power source to the wheeled luggage. When the luggage pulled by the user is too heavy, the luggage can generate an auxiliary power source, making the user able to pull the luggage with an easy effort when walking.

Secondly, the invention is to provide an auxiliary apparatus of wheeled luggage, including:

an electricity-generating unit, which is disposed onto a rotary axle, and which generates electricity when the rotary axle is rotating;

a charging unit, which is electrically connected to the electricity-generating unit and adapted for receiving an electricity output therefrom;

a storage unit, which is electrically connected to the charging unit and adapted for receiving an electricity output therefrom;

a sensing unit, which is disposed onto a wheel set and adapted for sensing a rotation speed thereof;

a control unit, which is electrically connected to the storage unit and the sensing unit for receiving an electricity output from the storage unit and a signal output from the sensing unit to output a control signal, and in which there is a memory installed, which stores parameter values of rotation speeds of the wheel set;

a driving unit, which is electrically connected to the control unit and adapted for receiving the control signal output from the control unit;

an actuating unit, which is electrically connected to the driving unit and adapted for receiving a driving signal output from the driving unit to generate a power source of high rotation speed and small torque; and

a transmission unit, which is mechanically connected to the actuating unit and adapted for receiving the power source of high rotation speed and small torque output from the actuating unit, which is converted into a power source of low rotation speed and large torque, which in turn brings along an output axle extended to an exterior of the transmission unit and a gear arranged onto the output axle and engaged with a gear arranged on the rotary axle, making the wheel set generate a rotation of large torque.

Thereby, the auxiliary power source generated from the auxiliary apparatus can make a user pull the wheeled luggage with an easy effort when walking.

BRIEF DESCRIPTION OF DRAWING

The features of the invention believed to be novel are set forth with particularity in the appended claims. The invention itself, however, may be best understood by reference to the following detailed description, which describes a number of embodiments of the invention, taken in conjunction with the accompanying drawings, in which:

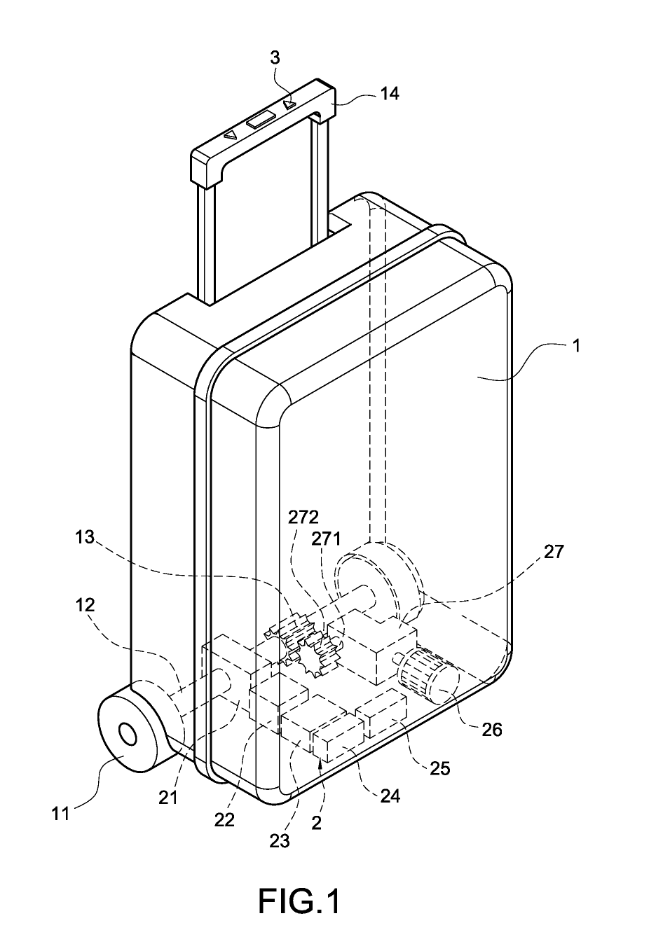

FIG. 1 is an outer perspective illustration of a luggage according to the present invention;

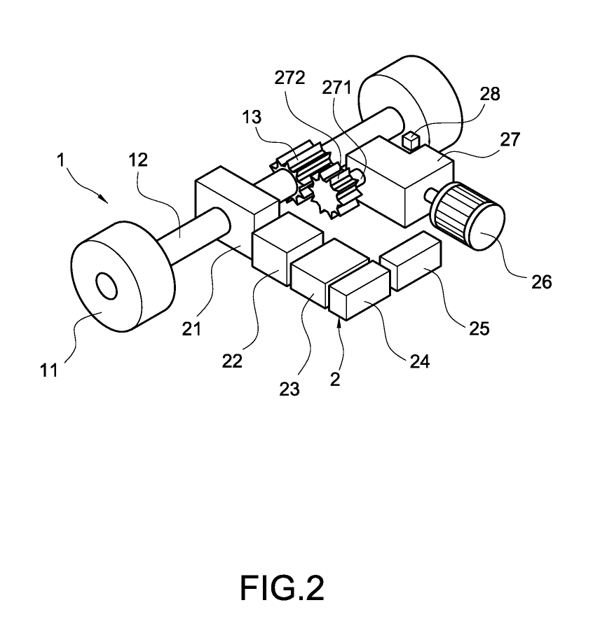

FIG. 2 is an outer perspective illustration of an auxiliary apparatus according to the present invention;

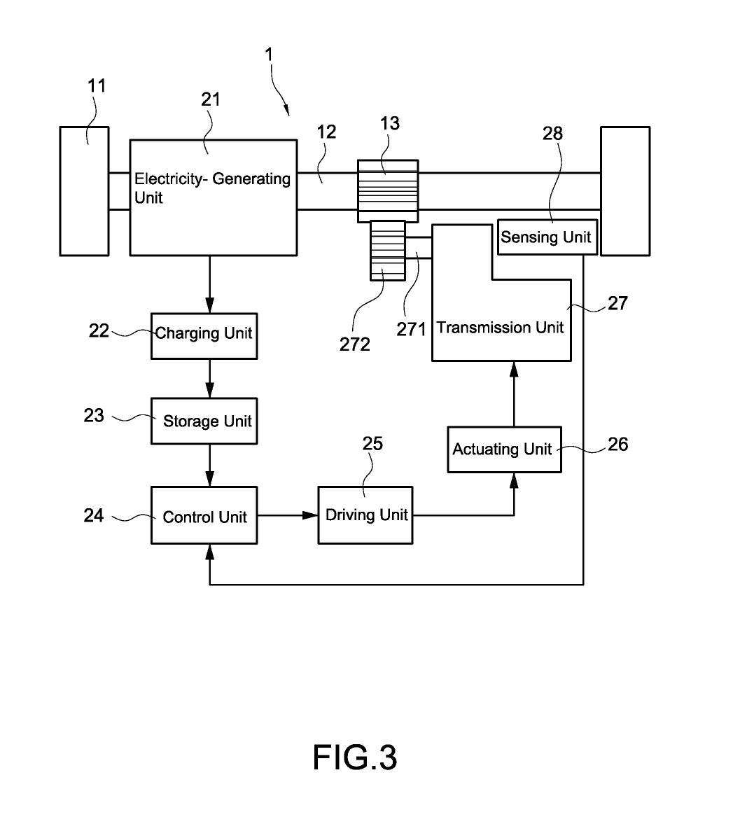

FIG. 3 is a circuit block illustration of an auxiliary apparatus according to the present invention; and

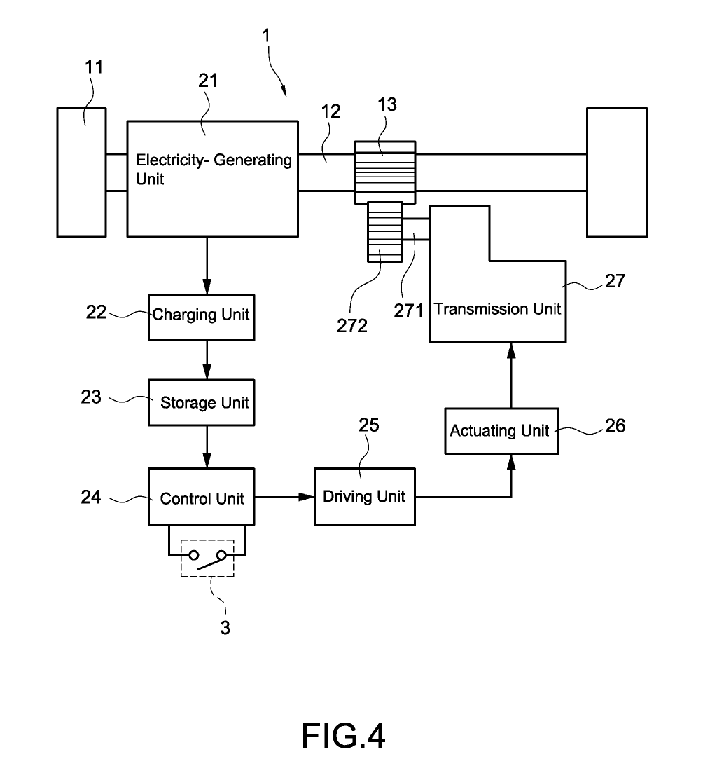

FIG. 4 is a circuit block illustration of an auxiliary apparatus according to another embodiment of the present invention.

### DETAILED DESCRIPTION OF THE INVENTION

In cooperation with attached drawings, the technical contents and detailed description of the present invention are described thereinafter according to a number of preferable embodiments, not used to limit its executing scope. Any equivalent variation and modification made according to appended claims is all covered by the claims claimed by the present invention.

Please refer to FIG. 1, which is an outer perspective illustration of a luggage according to the present invention. As shown in this figure: the auxiliary apparatus of a wheeled luggage capable of being pulled by a user when walking is mainly to dispose an auxiliary apparatus 2 onto a wheel set 11 of a luggage 1. When a user is walking and pulling the wheeled luggage, the auxiliary apparatus 2 arranged therein will self-sense the rotation speed of the wheel set 11. After judging the speed, the auxiliary apparatus will decide to output a power source or not. Or, when pulling the luggage 1, if the user feels the luggage 1 is too heavy, he can push down a switch unit 3 on a pull rod 14 to actuate the auxiliary apparatus 2 to generate a power transmitted to the wheel set 11. Thus, the user can pull the luggage 1 with an easy effort during walking.

Please refer to FIG. 2 and FIG. 3, which respectively are an outer perspective illustration and a circuit block illustration of the auxiliary apparatus according to the present invention.

As shown in these figures: the auxiliary apparatus 2 includes an electricity-generating unit 21, a charging unit 22, a storage unit 23, a control unit 24, a driving unit 25, an actuating unit 26, a transmission unit 27 and a sensing unit 28.

The electricity-generating unit 21, which is disposed onto a rotary axle 12 of the wheel set 11, generates an output of electricity, when the rotary axle 12 is brought along by the wheel set 11 to rotate. In this embodiment, the electricity-generating unit 21 is a generator.

The charging unit 22, which is electrically connected to the electricity-generating unit 21, is adapted for receiving the electricity output from the electricity-generating unit 21. In this embodiment, the charging unit 22 is a charging circuit.

The storage unit 23, which is electrically connected to the charging unit 22, is adapted for receiving the electricity output from the charging unit 22. In this preferable embodiment, the storage unit 23 is a rechargeable battery.

The control unit 24, which is electrically connected to the storage unit 23, is adapted for outputting a control signal, when a memory arranged therein and stored the parameter values of the rotation speeds of the wheel set 11 receives the electricity output from the storage unit 23 and receives the sensing signal fed back from the sensing unit 28. In this embodiment, the control unit 24 is any kind of CPU, MCU, and PLU.

The driving unit 25, which is electrically connected to the control unit 24, is adapted for receiving the control signal output therefrom to generate an output of driving signal.

The actuating unit 26, which is electrically connected to the driving unit 25, is adapted for receiving the driving signal output therefrom to generate an output of power source of high rotation speed and small torque. In this embodiment, the actuating unit 26 is a motor.

The transmission unit 27, which is mechanically connected to the actuating unit 26, is adapted for receiving the power source of high rotation speed and small torque output from the actuating unit to output another power source of low rotation speed and high toque, which is transferred to and brings along an output axle 271 extended to an exterior of the transmission unit 27 and a gear 272 arranged thereon. In the meantime, a gear 13 arranged on a rotary axle 12 and engaged with the gear 272 is actuated, making the wheel set 11 generate a rotation of large torque. In this embodiment, the transmission unit 27 is a decelerator.

The sensing unit 28, which is disposed onto the wheel set 11 and electrically connected to the control unit 24, is adapted for sensing the rotation speeds of the wheel set 11 and transferring the sensed values to the control unit 24. Comparing the received values with the parameter values stored in the memory, if the rotation speed of the wheel set 11 is too slow, the control unit 24 will output a control signal, which is transmitted through the driving unit 25, the actuating unit 26 and the transmission unit 27, all together of which will actuate the wheel set 11 to rotate. Thus, the user can pull the wheeled luggage 1 with an easy effort, when walking. In this embodiment, the sensing unit 28 is a sensor of rotation speed.

Please refer to FIG. 4, which is a circuit block illustration of an auxiliary apparatus of wheeled luggage according to another embodiment of the present invention. Please refer together to the FIG. 1. As shown in this figure: when the user is pulling the luggage 1, if he feels that the luggage 1 is too heavy to pull, he can push down a switch unit 3 arranged on a pull rod 14 of the luggage 1 and generating a signal transferred to the control unit 24. Then, the control unit 24 outputs a control signal, which is transmitted through the driving unit 25, the actuating unit 26 and the transmission unit 27, all together of which will actuate the wheel set 11 to rotate, making the user able to pull the luggage 1 with an easier effort when walking. At this time, the auxiliary power source can be output, even without the reaction of the sensing unit 28.

Therefore, through the constitution of aforementioned assemblies, an auxiliary apparatus of wheeled luggage according to the invention is thus obtained.

Summarizing aforementioned description, the auxiliary apparatus according to the present invention is an indispensable apparatus for a wheeled luggage indeed, which may positively reach the expected usage objective for solving the drawbacks of the prior arts, and which extremely possesses the innovation and progressiveness to completely fulfill the applying merits of a new type patent, according to which the invention is thereby applied. Please examine the application carefully and grant it as a formal patent for protecting the rights of the inventor.

However, the aforementioned description is only a number of preferable embodiments according to the present invention, not used to limit the patent scope of the invention, so equivalently structural variation made to the contents of the present invention, for example, description and drawings, is all covered by the claims claimed thereinafter.

What is claimed is:

1. An auxiliary apparatus of wheeled luggage, adapted to be disposed in a luggage and onto a rotary axle of a wheel set, capable of generating an auxiliary power source to bring along a gear arranged onto the rotary axle to rotate, including:
an electricity-generating unit, which is disposed onto the rotary axle, and which generates an output of electricity when the rotary axle is rotating;
a charging unit, which is electrically connected to the electricity-generating unit and adapted for receiving an electricity output therefrom;
a storage unit, which is electrically connected to the charging unit and adapted for receiving an electricity output therefrom;
a sensing unit, which is disposed onto the wheel set and adapted for sensing a rotation speed thereof;
a control unit, which is electrically connected to the storage unit and the sensing unit for receiving an electricity output from the storage unit and a signal output from the sensing unit to output a control signal, and in which there is a memory installed, which stores parameter values of rotation speeds of the wheel set;
a driving unit, which is electrically connected to the control unit and adapted for receiving the control signal output therefrom;
an actuating unit, which is electrically connected to the driving unit and adapted for receiving a driving signal output therefrom to generate a power source of high rotation speed and small torque; and
a transmission unit, which is mechanically connected to the actuating unit and adapted for receiving the power source of high rotation speed and small torque output therefrom, which is converted into a power source of low rotation speed and large torque, which in turn brings along an output axle extended to an exterior of the transmission unit and a gear arranged onto the output axle engaged with the gear arranged on the rotary axle, making the wheel set generate a rotation of large torque.

2. The auxiliary apparatus according to claim 1, wherein the electricity-generating unit is a generator.

3. The auxiliary apparatus according to claim 1, wherein the charging unit is a charging circuit.

4. The auxiliary apparatus according to claim 1, wherein the storage unit is a rechargeable battery.

5. The auxiliary apparatus according to claim 1, wherein the control unit is any kind of CPU, MCU, and PLC.

6. The auxiliary apparatus according to claim 1, wherein the sensing unit is a sensor of rotation speed.

7. The auxiliary apparatus according to claim 1, wherein the actuating unit is a motor.

8. The auxiliary apparatus according to claim 1, wherein the transmission unit is a decelerator.

9. An auxiliary apparatus of wheeled luggage, adapted to be disposed in a pull rod of a luggage and onto a rotary axle of a wheel set, capable of generating an auxiliary power source to bring along a gear arranged onto the rotary axle to rotate, including:
an electricity-generating unit, which is disposed onto the rotary axle, and which generates an output of electricity when the rotary axle is rotating;
a charging unit, which is electrically connected to the electricity-generating unit and adapted for receiving an electricity output therefrom;
a storage unit, which is electrically connected to the charging unit and adapted for receiving an electricity output therefrom;
a switch unit, which is disposed onto the pull rod and adapted for generating an actuating signal to be output;
a control unit, which is electrically connected to the storage unit and the switch unit for receiving an electricity output from the storage unit and an actuating signal output from the switch unit to output a control signal, and in which there is a memory installed, which stores parameter values of rotation speeds of the wheel set;
a driving unit, which is electrically connected to the control unit and adapted for receiving the control signal output from the control unit;
an actuating unit, which is electrically connected to the driving unit and adapted for receiving a driving signal output therefrom to generate a power source of high rotation speed and small torque; and
a transmission unit, which is mechanically connected to the actuating unit and adapted for receiving the power source of high rotation speed and small torque output therefrom, which is converted into a power source of low rotation speed and large torque, which in turn brings along an output axle extended to an exterior of the transmission unit and a gear arranged onto the output axle engaged with the gear arranged on the rotary axle, making the wheel set generate a rotation of large torque.

10. The auxiliary apparatus according to claim 9, wherein the electricity-generating unit is a generator.

11. The auxiliary apparatus according to claim 9, wherein the charging unit is a charging circuit.

12. The auxiliary apparatus according to claim 9, wherein the storage unit is a rechargeable battery.

13. The auxiliary apparatus according to claim 9, wherein the control unit is any kind of CPU, MCU, and PLC.

14. The auxiliary apparatus according to claim 9, wherein the sensing unit is a sensor of rotation speed.

15. The auxiliary apparatus according to claim 9, wherein the actuating unit is a motor.

16. The auxiliary apparatus according to claim 9, wherein the transmission unit is a decelerator.
